(19) United States
(12) Patent Application Publication
(10) Pub. No.: US 2004/0146229 A1
(43) Pub. Date: Jul. 29, 2004

(54) Lubricated sliding system and method for minimizing friction

(75) Inventors: Axel Kratzsch, Altheim (DE); Volker Lagemann, Ulm (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/719,439

(22) Filed: Nov. 20, 2003

(30) Foreign Application Priority Data
Nov. 21, 2002 (DE) DE102 54 368.2-12

(51) Int. Cl. F16C 33/02

(52) U.S. Cl. 384/276

(57) ABSTRACT

A lubricated or wet-friction sliding system having minimized friction, in particular under dynamic load, including a smooth and hard base member and a counter member having an elastic friction surface that is structured to form lubricant reservoirs which release lubricant into the sliding surface when the two sliding members are pressed together, as well as a method for manufacturing and structuring the elastic friction surface.

Priority is claimed to German Patent Application No. DE 102 54 368.2-12, filed on Nov. 21, 2002, the entire disclosure of which is incorporated by reference herein.

### BACKGROUND

The present invention relates to lubricated or wet-friction sliding systems having minimized friction, in particular under impact force, including a smooth and hard base member and a counter member having an elastic friction surface, as well as a method for manufacturing and structuring the elastic friction surface.

In engines, pumps, guides, and shaft bearings, where different members are positioned so that they slide relative to each other, it is necessary to design the contact or friction surfaces in such a way that they have as little friction as possible. This is usually achieved by manufacturing friction surfaces that are very smooth and even, i.e., without a surface profile. In particular, care is taken to prevent or eliminate bumps and indentations during the manufacturing process.

Another way to minimize friction is to use lubricants that are located in the contact gap between the friction surfaces. To reduce friction, i.e., in particular to reduce wear during operation, these wet-friction systems rely on the presence of the lubricating film. If the film breaks away, for example locally, or is displaced from the contact surface, dry friction occurs in these locations due to the direct contact between the friction surfaces. This invariably results in increased wear and a dramatic change in friction performance, in particular in a great increase of the coefficient of friction. In this case, the frictional resistance and wear would be very high, possibly resulting in unwanted seizing of the two friction members.

The danger of the lubricating film breaking away is present, in particular, at low speeds of the friction surfaces relative to each other, for example in pistons or shaft bearings operating under conditions that are close to the idle position. The danger of lubricant displacement is particularly high when dynamic loads act upon the friction surfaces in the case of small gap widths, generating high pressure peaks.

In a sliding system that includes a base member and a counter member, an object of the present invention is to provide a friction surface for the counter member that ensures minimized friction even at low speeds of the friction surfaces relative to each other and under dynamic loads, as well as a method for manufacturing the friction surface.

The present invention provides a sliding system including a smooth base member and a counter member (the sliding members), the sliding member having a friction layer made of an elastic material in which recesses or indentations are included as a reservoir for the lubricant and which are suitable for releasing lubricant into the contact surface upon breaking away of the lubricating film or under impact force. It is provided in particular that the elastic material of the friction surface yields under compressive stress in such a way that the volume of the recesses or indentations is reduced. The recesses or indentations (the terms recesses and indentations being used interchangeably herein) according to the present invention are positioned discretely so that they are unable to communicate with each other. Thus, due to the compression of the recesses or indentations, lubricant is forced into the contact surface.

### BRIEF DESCRIPTION OF THE DRAWINGS

The sliding system according to the present invention and the principle of minimizing friction are explained in greater detail in the schematic drawings, in which:

FIG. 1 shows one embodiment of a sliding system according to the present invention without compressive stress (A), under low compressive stress (B), and under high compressive stress (C); and

FIG. 2 shows a second embodiment of a sliding system according to the present invention without compressive stress (A), under low compressive stress (B), and under high compressive stress (C).

### DETAILED DESCRIPTION

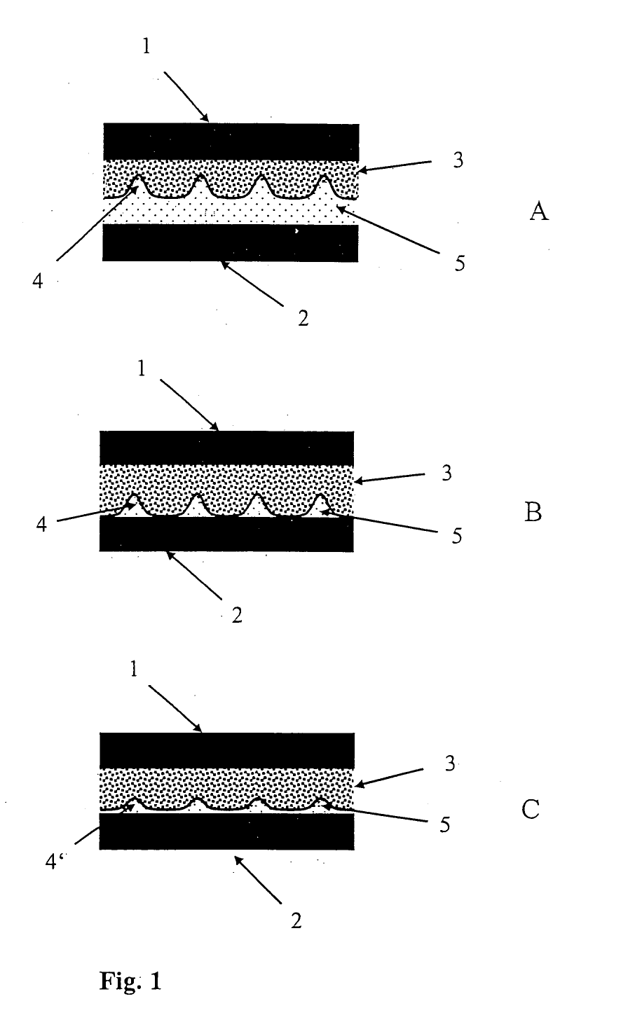

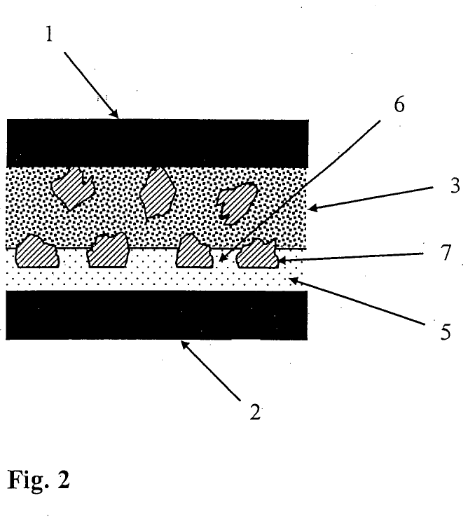

In both FIGS. 1 and FIG. 2, counter member (1) has a friction surface (3) made of an elastic material, as well as a thick film of lubricant (5), and base member (2) having a smooth friction surface. In FIG. 1, the elastic friction surface (3) forms recesses or indentations (4). In FIG. 2, particles of hard material (7), projecting partially from the surface, are embedded into the elastic friction surface (3).

The friction surface of counter member (1) according to the present invention thus has a multitude of compressible lubricant reservoirs that are formed by recesses or indentations (4) in elastic material (3). Under compressive stress, the friction surface of the counter member is pressed against the surface of the base member (FIG. 1, B), the lubricant being increasingly displaced from the contact gap. The elastic material is compressed under rising pressure, whereby the reservoirs are also pressed together. Because the lubricant is a nearly incompressible fluid, it is pressed out of the reservoirs into the contact surface (FIG. 1, C). When the compressive stress decreases, the reservoirs return to their original geometry and are again filled with lubricant (FIG. 1, B). This mechanism reliably supplies the contact gap with lubricant, in particular under impact forces, thereby suppressing the unwanted dry friction.

Even in the case of minimal sliding movements, where usually a high degree of mixed friction is to be expected, the reservoirs may supply lubricant to the contact gap and prevent the film from breaking away.

It is easy to see that, under increasing and sustained pressure, the reservoirs are fully compressed, preventing the release of further lubricant. In this case, the elastic material will be pressed directly onto the smooth counter member over a wide area, thereby forming the friction contact itself. As a result, the function of the illustrated friction-minimizing system relies on pressure relief phases in which the elastic material of the friction surface may spring back, and the reservoirs may expand to their original state. The reservoirs are then refilled with lubricant.

Because the complete displacement of lubricant is not entirely avoidable under load peaks, it is suitable to use as the elastic material a material that has good sliding properties vis-à-vis the smooth surface of the base member.

The elastic material must have a much higher compressibility than the material of the remaining counter member and the base member.

Common materials for the counter member and the base member are metals, in particular steels or light alloys. Less commonly, ceramic materials are also used for this purpose.

However, the selection of the material is not limited to the materials listed above, since the functional principle of friction pairing requires only a substantial difference in the modulus of elasticity, i.e., compressibility. The hardness of the base member material is preferably equal to or higher than that of the counter member. In particular, hard plastics are also suitable for the counter member.

The elastic material is made of polymer materials or plastics, in particular elastomers or rubber. The material compressibility may be oriented toward the requirements of the individual application. The plastic preferably includes one or more materials from the group of fluorinated or perfluorinated hydrocarbons, polyolefines or silicones.

The elastic material should be both easily wettable and have a high chemical resistance to the lubricant. Thus, polytetrafluor ethylene (PTFE; for example, Teflon®) or silicones are preferably used for oils.

The function of the friction surface according to the present invention depends on the fact that the lubricant is less compressible than the elastic material having recesses or indentations. All common lubricants meet this condition. This includes both aqueous lubricant systems and oil-based lubricant systems. The oil is generally a conventional petroleum raffinate or a synthetic polyolefine or ester. Aqueous systems may be, for example, glycols or polyglycols.

Although the recesses or indentations, hereinafter also referred to as the reservoir, may in principle assume nearly any geometric shape, cup, trough, or groove shapes are particularly suitable. It is essential that the individual reservoirs are not continuously interconnected. At most, only small areas of the recesses or indentations should be interconnected. Locally adjacent areas of interconnected or communicating reservoirs are not disadvantageous, provided that the size of the individual areas does not, on average, exceed approximately 30 reservoirs or 5 percent of the entire friction surface.

The geometric dimensions of the reservoirs range from several μm to several mm. The diameter surrounding the reservoirs on the plane of the sliding contact ranges, according to the present invention, from 0.1 μm to 5 mm, preferably from 1 to 3,000 μm and especially preferably from 5 to 1,000 μm. The depth of individual reservoirs generally assumes values smaller than those of the corresponding diameter. The ratio between depth (t) and diameter (d) ranges from 0.01 to 10, preferably from 0.1 to 1, and especially preferably t/d<0.5.

Typically, recesses or indentations cover at least 10 percent of the friction surface area. The local distribution and/or the size thereof are adjustable to the individual load. For example, fewer reservoirs are needed in areas of great cubic capacity, since transverse forces, i.e., forces perpendicular to the sliding surfaces, tend to occur less frequently here.

The compressibility of the elastic material lies in a range that allows for deformation of the reservoir under the normal maximum pressure applied to the sliding system, causing the t/d ratio to change by at least 5 percent, preferably 30 percent, and especially preferably 90 percent relative to the t/d ratio in a pressureless state.

According to a further advantageous embodiment of the present invention, the reservoirs vary in size, at least with regard to their depth. This ensures that the lubricant is evenly dispensed over a variable pressure range. The smaller reservoirs, i.e., those having a smaller volume, are in fact emptied at lower pressures compared to the larger reservoirs, so that an adequate number of filled reservoirs is always available across a wide range of pressures.

According to a further variant of the present invention, the side walls of the recesses or indentations are at least partially reinforced by hard materials or are at least partially made of hard materials. FIG. 2 shows the fundamental layout of a friction layer of this type. Elastic material (3) is interspersed with hard material particles (7) which project partially from the surface of the elastic material. The volume between the hard material particles corresponds to reservoirs (6) that are at least partially limited by hard material. The elastic material preferably includes other hard material particles which do not project from the surface. The hard material particles which project from the surface are generally also surrounded by a thin layer of the elastic material; the layer on the side that is in contact with the base member may be reduced relatively quickly by the friction contact.

As the friction layer is compressed, the pressure, in turn, reduces the volume of the reservoirs and presses the lubricant into the contact surface (or gap). The elastic material is then pressed into space (6) formed by the projecting hard material particles. The use of hard material particles helps reinforce the surface of the plastic material. Since the plastic material is always the softer friction member in the sliding system, it is naturally also subject to greater wear. The use of hard material particles therefore considerably reduces wear on this material layer. The limits described above for the hard material-free variants also apply to the size or dimensions of the reservoirs, as well as to the hard material particles. In this case, the areas of communicating reservoirs may be dimensioned slightly larger than in the hard material-free variants. On average, the individual areas are preferably smaller than 10 percent of the entire friction surface. Suitable hard material particles are, in particular, carbides, such as SiC, TiC, and WC, or oxides, such as ZrO₂ and Al₂O₃, or metals and alloys made of steel, Mo, W, Cu, Pb, or Sn.

It is also possible to use a plastic that has been reinforced with hard material particles as the elastic material. In contrast to the variants described above, the particles in this case are much smaller than the corresponding recesses or indentations. The particles are so fine and homogeneously distributed in the plastic that the material behaves like an isotropic, particle-reinforced plastic. The filling ratio in the plastic should not be so large that the friction layer formed thereby loses its elastic properties. Therefore, low-volume plastics with filling ratios (in volume fractions) of less than approximately 30 percent are typically used.

Thickness d of the elastic friction layer, which may also contain hard materials if necessary, is at least equal to depth t of the recesses or indentations, but preferably higher than 2*t. If the reservoirs vary in size, t is the maximum value for depth.

The contact surface between the counter member and its friction surface is ordinarily not smooth, but rough, to improve adhesion.

Conventional plastic coating methods may be used to manufacture the friction layers according to the present invention. Among other things, this includes gum coating, fluid-coating using curable coating solutions, or spray coating.

A further method step is microforming to form the recesses or indentations.

According to an extremely suitable manufacturing variant, the surface structure is pressed into the freshly applied and still soft, i.e., not yet cured, plastic layer on the counter member. This is preferably done using section rolls. It is particularly preferable for the section rolls to be provided with pyramid-shaped or cylindrical relief patterns or pins.

According to a further variant, the elastic material is applied, for example by screen-printing of a plastic solution. Screen-printing is particularly suitable for particle-filled plastics. This makes it possible to easily produce even complex surface profiles. A lattice pattern made of plastic is preferably applied. The webs in the lattice form the lateral boundaries of the reservoirs. The base material of the counter member forms the bottom of the reservoir. In this case, depth t of the reservoirs and thickness d of the friction layer are identical.

The sliding systems according to the present invention are particularly suitable for guides of moving parts that are exposed to impact forces from different spatial directions.

An advantageous application is in guides for shock absorber components (rod or piston guide). Shock absorbers are subject, at certain points, to strong impact forces which frequently also have substantial transverse components relative to the stroke (parallel to the longitudinal direction of the shock absorber), due to the load pattern. The loads are highly dynamic, i.e., they frequently alternate between load and load-free phases.

The sliding system according to the present invention also has advantages in guide elements for steering systems or braking systems. In this case, impact forces, having, in part, a substantial amount of transverse components relative to the preferred sliding direction, also occur under application conditions, in particular in motor vehicles.

What is claimed is:

1. A lubricated sliding system comprising:
a base member having a smooth and hard first friction surface; and
a counter member having an elastic friction surface and including hard materials at least partially projecting from the elastic friction surface, wherein the elastic friction surface forms a plurality of lubricant-receiving recesses having side surfaces formed by the hard materials, the recesses being reversibly compressible under an application of pressure.

2. The lubricated sliding system as recited in claim 1, wherein the plurality of recesses are not interconnected.

3. The lubricant sliding system as recited in claim 1, wherein at least some of the recesses are interconnected through small interconnecting areas.

4. The lubricated sliding system as recited in claim 1, further comprising a lubricant and wherein a compressibility of the elastic friction surface is higher than a compressibility of the lubricant.

5. The lubricated sliding system as recited in claim 1, wherein the elastic friction surface includes at least one of a plastic and an elastomer.

6. The lubricated sliding system as recited in claim 5, wherein the hard material particles are at least partially covered by a thin layer of the plastic or elastomer.

7. The lubricated sliding system as recited in claim 5, wherein the plastic includes at least one of a fluorinated hydrocarbon, a perfluorinated hydrocarbon, a polyolefine, and a silicone.

8. The lubricated sliding system as recited in claim 1, wherein each of the recesses in the friction surface have a diameter ranging from 0.1 μm to 5 mm.

9. The lubricated sliding system as recited in claim 1, wherein the recesses have a depth-to-diameter ratio of 0.01 to 10.

10. The lubricated sliding system as recited in claim 1, wherein a volume of the recesses varies in size.

11. The lubricated sliding system as recited in claim 1, wherein the counter member includes a base material and a depth of the recesses extends to the base material.

12. The lubricated sliding system as recited in claim 1, wherein the hard materials are formed by particles including at least one of SiC, TiC, WC, ZrO₂, Al₂O₃,.

13. The lubricated sliding system as recited in claim 1, wherein the materials are formed by particles including an alloys of at least one of the elements Mo, W, Cu, Pb, and Sn.

14. The lubricated sliding system as recited in claim 1, wherein the first friction surface is metallic.

15. The lubricated sliding system as recited in claim 1, wherein the lubricating sliding system is part of one of a shock absorber, a steering system, and a brake system of a vehicle.

16. The lubricated sliding system as recited in claim 1, wherein the lubricating sliding system is part of at least one of a shaft bearing and a piston guides of a drive system in a motor vehicle.
